(19) United States
(12) Patent Application Publication
(10) Pub. No.: US 2009/0324793 A1
(43) Pub. Date: Dec. 31, 2009

(54) Method of impoving taste of natural sweetener and composition thereof

(75) Inventors: Shuwang Zheng, Shandong (CN); Guangsan Che, Shandong (CN); Qiang Huo, Shandong (CN)

Correspondence Address: DAVID AND RAYMOND PATENT FIRM, 108 N. YNEZ AVE., SUITE 128, MONTEREY PARK, CA, 91754, US

(73) Assignee: Diamond Nutricentical, Inc.

(21) Appl. No.: 12/215,494

(22) Filed: Jun. 26, 2008

(51) Int. Cl. A23L 1/236

(52) U.S. Cl. 426/548

(57) ABSTRACT

A natural sweetener composition includes a predetermined amount of stevioside, a predetermined amount of dextrin, having a dextrose equivalent value, and a predetermined amount of enzyme, wherein the stevioside, the dextrin and the enzyme are chemically mixed together under a temperature in a range of approximately 40 Celsius degrees to 80 Celsius degrees and for a period of time of approximately 3 hours to 30 hours to form a solution containing a predetermined amount of alpha-glycosyl stevioside, with a conversion rate from the stevioside to the alpha-glycosyl stevioside in a range between approximately 60% to 86%.

### BACKGROUND OF THE PRESENT INVENTION

1. Field of Invention

The present invention relates to sweetener, and more particularly to a taste enhanced natural sweetener comprising a predetermined amount of stevioside and a predetermined amount of dextrin which are mixed together under a specific process for substantially enhancing a taste of the resulting sweetener.

2. Description of Related Arts

Natural sweetener have widely been used throughout the world as a substitute of sugar, which is perceived by many as containing high calories, and being responsible for making people fat. Many natural sweeteners use Stevia leaves as a raw material for generating sweet taste. In fact, extracts of Stevia contain compounds such as stevioside, rebaudioside (A, B, C, D and E) and Dulco Side A which are capable of providing sweet taste when they are used in producing sweeteners.

Among these compounds, Stevioside is a sweet compound of the glycoside class obtained from the leaves of a Paraguayan shrub and used as a food sweetener for many years. The Paraguayan shrub is known as Stevia Rebaudiana Bertoni which is a member of the Chrysanthenum family. Scientifically, stevioside is approximately 200-300 times sweeter than the same amount of typical sucrose, yet it contains approximately one-two-hundredth to one-three-hundredth amount of calories than sucrose. Since intake of large amount of traditional source sweet-containing food (i.e. sucrose) may lead to undesirable health problems, such as diabetes and heart attack, natural sweeteners have been widely accepted and utilized in many developed countries and regions. In those places, natural sweeteners are used in producing a wide variety of products, such as foods, drinks, wines, and even health supplements.

A major disadvantage of such natural sweetener as stevioside is that although it provides the desirable sweet taste for many food products, it also contains other tastes (notably bitterness and strange sweet taste when compared with traditional sucrose-made food product) which may make stevioside an unsuitable agent for use in certain food products. Conventionally, there exist many strategies for mitigating the effect of this problem.

First, some people may mix other organic solvents with stevioside in order to enhance the taste of the resulting sweetener. However, the use of other organic solvents may increase the manufacturing cost of the resulting sweetener and may, depending on the organic solvent used, impart some harmful effect to the person consuming the resulting sweetener.

Second, some people may mix a large amount of non-protein amino acid with stevioside to produce a sweetener which has an enhanced sweet taste. The problem with this strategy is that non-protein amino acid may increase the calories of the resulting sweetener, thus defeating the very purpose by many people when they choose to consume sweetener instead of traditional sugar.

Third, some people may mix a large amount of other glucose-related products into stevioside so as to make the resulting sweetener taste more like traditional sugar. This strategy is not satisfactory because when one needs to rely on traditional sugar product to enhance the taste of natural sweetener, that natural sweetener is simply not suitable as a sugar substitute. This kind of natural sweetener may perhaps have certain market values, yet from the technical point of view, there is little benefit in developing this kind of natural sweetener because it relies on traditional sugar products for enhancing its sweet taste.

U.S. Pat. No. 4,219,571 to Miyake generally discloses a processing for producing sweetener containing alpha-glycosyl stevioside, wherein the method comprises the steps of allowing alpha-glucosyltransferase to react on an aqueous solution containing stevioside and alpha-glucosyl sugar compound for a time sufficient to produce the alpha-glycosyl stevioside. The problem with the disclosure in Miyake is that the possible ranges of several major ingredients of the sweetener are so wide that one of ordinary skill in the art would not be able to make a sweetener with an optimally enhanced sweet taste.

### SUMMARY OF THE PRESENT INVENTION

A main object of the present invention is to provide a taste enhanced natural sweetener comprising a predetermined amount of stevioside and a predetermined amount of dextrin which are mixed together under a specific process for substantially and optimally enhancing a taste of the resulting sweetener.

Another object of the present invention is to provide a taste enhanced natural sweetener which can easily be manufactured by reference to a specific and clear set of ingredients compositions and their respective concentrations.

Another object of the present invention is to provide a taste enhanced natural sweetener which is suitable for mass production without inducing expensive manufacturing cost of the present invention.

Accordingly, in order to accomplish the above objects, the present invention provides a natural sweetener composition, comprising:

a predetermined amount of stevioside, having a percentage by weight of approximately 10 to approximately 18;

a predetermined amount of dextrin, having a percentage by weight of 10 to 19, wherein the dextrin has a dextrose equivalent value in a range of approximately 4 to approximately 30; and

a predetermined amount of enzyme, having a percentage by weight of approximately 0.06 to approximately 0.25,

wherein the stevioside, the dextrin and the enzyme are chemically mixed together under a temperature in a range of approximately 40 Celsius degrees to approximately 80 Celsius degrees and for a period of reaction time of approximately 3 hours to approximately 30 hours too form a sweetener solution containing a predetermined amount of alpha-glycosyl stevioside, with a conversion rate from the stevioside to the alpha-glycosyl stevioside in a range between approximately 60% to approximately 86%.

Moreover, the present invention also provides a method of manufacturing a natural sweetener, comprising a step of mixing a predetermined amount of stevioside with a predetermined amount of dextrin through a predetermined amount of enzymes under conditions that the predetermined amount of stevioside has a percentage by weight of approximately 10 to approximately 18, the predetermined amount of dextrin has a percentage by weight of 10 to 19, wherein the dextrin has a dextrose equivalent value in a range of approximately 4 to approximately 30, the predetermined amount of enzyme has a percentage by weight of approximately 0.06 to approximately 0.25, wherein the stevioside, the dextrin and the enzyme are chemically mixed together under a temperature in a range of approximately 40 Celsius degrees to approximately 80 Celsius degrees and for a period of reaction time of approximately 3 hours to approximately 30 hours to form a sweetener solution containing a predetermined amount of alpha-glycosyl stevioside, with a conversion rate from the stevioside to the alpha-glycosyl stevioside in a range between approximately 60% to approximately 86%.

These and other objectives, features, and advantages of the present invention will become apparent from the following detailed description, the accompanying drawings, and the appended claims.

### BRIEF DESCRIPTION OF THE DRAWINGS

FIG. 1 is a table of the ingredients of the natural sweetener according to a preferred embodiment of the present invention.

FIG. 2 is table listing the sweetening effect of the natural sweetener according to the above preferred embodiment of the present invention.

### DETAILED DESCRIPTION OF THE PREFERRED EMBODIMENT

The present invention is to provide a process of improving the taste of quality of a natural sweetener consisting the steps of:

a) providing a predetermined aqueous solution of stevioside having a predetermined concentration;

b) providing a predetermined substrate with a predetermined dextrose equivalent (D.E.) and a predetermined concentration, wherein the quantity of the stevioside and the substrate is capable of being added to define as predetermined reactants;

c) providing a predetermined transferase in a predetermined quantity so as to maintain a predetermined trasferase ratio of the transferase and the reactants;

d) mixing the predetermined substrate, the predetermined transferase and the predetermined aqueous solution of stevioside, wherein the predetermined substrate, the predetermined transferase and the predetermined aqueous solution of stevioside are defined as starting materials before mixing; and

e) allowing the predetermined substrate, the predetermined transferase, and the predetermined aqueous solution to react for a predetermined reaction time under a predetermined controlled temperature to form a resulting product, namely α-glycosyl stevioside.

In order to analyze the percentage yield of the above process, we may have an additional step of analyzing the resulting product to define a predetermined percentage yield of the process, wherein the percentage yield is an indication of the completion of the reaction of the process which changes stevioside to α-glycosyl stevioside.

The above process of improving the taste of quality of a natural sweetener is capable of having a predetermined percentage yield by providing a predetermined condition of the process. The scope of the predetermined condition of the process are illustrated below.

The process of achieving a 60-80% percentage yield is under the conditions of having a 10-18% aqueous solution of stevioside, a 10-19% substrate with DE value 4-30, a trasferase ratio of 0.06-0.25%, a controlled temperature within 40-80° C, and a reaction time within 3-30 hours.

The process of achieving a 70-86% percentage yield is under the conditions of having a 13-16% aqueous solution of stevioside, a 13-15% substrate with DE value 4-20, a trasferase ratio of 0.09-0.22%, a controlled temperature within 55-80° C, and a reaction time within 9-18 hours.

The process of achieving a 82-86% percentage yield is under the conditions of having a 13-16% aqueous solution of stevioside, a 13-15% substrate with DE value 4-20, a trasferase ratio of 0.09-0.22%, a controlled temperature within 66-78° C., and a reaction time within 10-18 hours.

According to the above examples of predetermined conditions, the cost of production is increased by 12% while the value of the resulting product is dramatically increased by 50%. This gives a great economical advantage together with a structural change of the stevioside to improve the nature of the quality of taste.

Comparisons have been made between the natural sweetener before and after the process of the present invention and the results are illustrated as follow:

| Sweetness Equivalent | Before the process of the | After the process of the |
|---|---|---|
| (Compare with sucrose) | present invention | present invention |
| Equivalent to 5% sucrose | Sweet, Bitter, no unpleasant | Improve sweetness, pleasant, |
| solution | after-taste, relatively | taste similar to sucrose, no |
| | insoluble under ambient | unpleasant after-taste, easy to |
| | temperature, inconvenience | dissolve under ambient temperature, |
| | to use | convenience to use |
| Equivalent to 10% sucrose | Sweet, higher level of | Improve sweetness, pleasant, |
| solution | bitterness, relatively | taste similar to sucrose, no |
| | insoluble under ambient | unpleasant after-taste, easy to |
| | temperature | dissolve under ambient temperature, |
| | | convenience to use |
| Equivalent to 15% sucrose | Sweet, irritative, very high | High quality of sweetness, pleasant, |
| solution | level of bitterness, | taste similar to sucrose, no unpleasant |
| | inconvenience to use | after-taste, easy to dissolve under |
| | | ambient temperature, convenience to use |

After a full range of analysis, the first preferred embodiment of the process of the present invention comprising the steps of:

a) providing a predetermined aqueous solution of stevioside having a predetermined concentration;

b) adding a predetermined substrate with a predetermined dextrose equivalent (D.E.) and a predetermined concentration to the aqueous solution of stevioside, wherein the quantity of the stevioside and the substrate is capable of being added to define as predetermined reactants;

c) mixing the aqueous solution of stevioside and substrate thoroughly such that the substrate is completely dissolved to form a starting solution;

d) adding a predetermined transferase in a predetermined quantity to the starting solution to form a reacting solution;

e) allowing the reacting solution to react for a predetermined reaction time under a predetermined controlled temperature to form a resulting product.

According to the process of the invention as described above, a table of different examples of the first preferred embodiment is illustrated and summarized as below:

| | | | DE value | | Controlled | Reaction | |
|---|---|---|---|---|---|---|---|
| | Concentration | Concentration | of | Transferase | temperature | time | Percentage |
| Examples | of stevioside | of substrate | substrate | ratio | (° C.) | (Hours) | yield |
| 1 | 14 | 15 | 16 | 0.18 | 66 | 18 | 86 |
| 2 | 16 | 13 | 12 | 0.1 | 75 | 14 | 78 |
| 3 | 12 | 11 | 6 | 0.17 | 55 | 16 | 82 |
| 4 | 18 | 19 | 20 | 0.2 | 80 | 9 | 75 |
| 5 | 13 | 14 | 14 | 0.15 | 75 | 12 | 83 |

The substrate used in the process of the first preferred embodiment of the present invention is alpha-glucosyl sugar compound such as starch, dextrin, cyclodextrin and the likes while the respective types of transferase are glucosyltransferase, cyclodextrin glucanotransferase and the likes. One skilled in the art will understand the complimentary use of the substrate and the transferase in respect to the substrate.

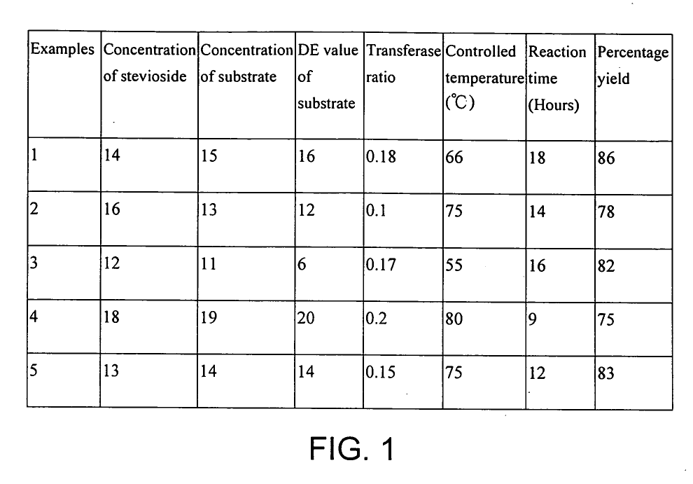

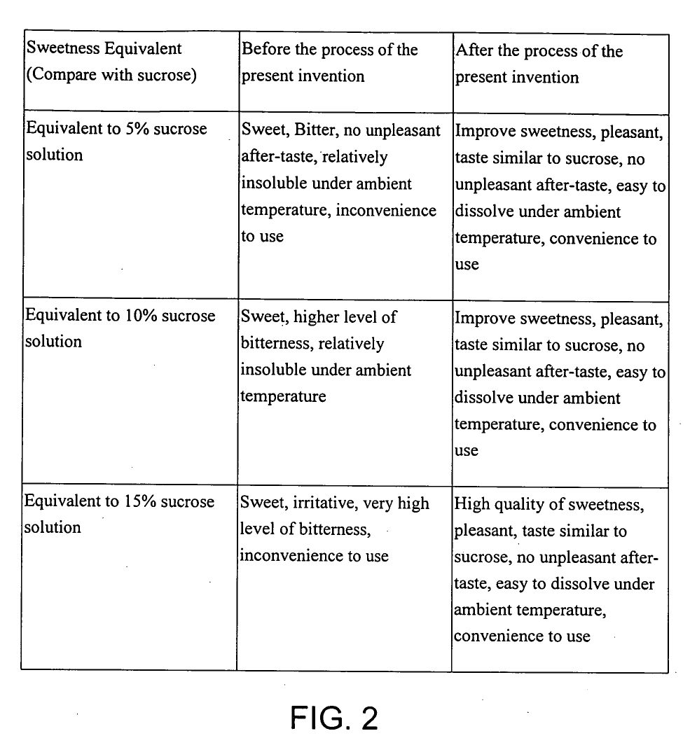

Referring to FIG. 1 to FIG. 2 of the drawings, a natural sweetener according to a preferred embodiment of the present invention is illustrated, in which the natural sweetener comprises a predetermined amount of stevioside, a predetermined amount of dextrin, and a predetermined amount of enzymes.

According to the preferred embodiment of the present invention, the present invention also provides a method of manufacturing a natural sweetener, comprising the following steps.

(1) Provide a predetermined amount of stevioside.

(2) Provide a predetermined amount of dextrin having an equivalent predetermined value of dextrose.

(3) Provide a predetermined amount of enzyme.

(4) Mix the stevioside, the dextrin, and the enzymes under conditions.

According to the preferred embodiment, the predetermined amount of stevioside has a percentage by weight of approximately 10 to approximately 18. The predetermined amount of dextrin has a percentage by weight of 10 to 19, wherein the dextrin has a dextrose equivalent value (DE value) in a range of approximately 4 to approximately 30.

The predetermined amount of enzyme has a percentage by weight of approximately 0.06 to approximately 0.25, wherein the stevioside, the dextrin and the enzyme are chemically mixed together under a temperature in a range of approximately 40 Celsius degrees to approximately 80 Celsius degrees and for a period of time of approximately 3 hours to approximately 30 hours to form a sweetener solution containing a predetermined amount of alpha-glycosyl stevioside, with a conversion rate from the stevioside to the alpha-glycosyl stevioside in a range between approximately 60% to approximately 86%.

According to the preferred embodiment of the present invention, for the most optimal enhanced taste of the natural sweetener, the predetermined amount of stevioside has a percentage by weight of approximately 13 to approximately 16. The predetermined amount of dextrin has a percentage by weight of 13 to 15, wherein the dextrin has a dextrose equivalent value (DE value) in a range of approximately 4 to approximately 20.

The predetermined amount of enzyme has a percentage by weight of approximately 0.09 to approximately 0.22, wherein the stevioside, the dextrin and the enzyme are chemically mixed together under a temperature in a range of approximately 55 Celsius degrees to approximately 80 Celsius degrees and for a period of time of approximately 9 hours to approximately 18 hours to form a sweetener solution containing a predetermined amount of alpha-glycosyl stevioside, with a conversion rate from the stevioside to the alpha-glycosyl stevioside in a range between approximately 70% to approximately 86%.

In order to further enhance the sweetness taste of the natural sweetener, the predetermined amount of stevioside has a percentage by weight of approximately 13 to approximately 16. The predetermined amount of dextrin has a percentage by weight of 13 to 15, wherein the dextrin has a dextrose equivalent value (DE value) in a range of approximately 4 to approximately 20.

The predetermined amount of enzyme has a percentage by weight of approximately 0.09 to approximately 0.22, wherein the stevioside, the dextrin and the enzyme are chemically mixed together under a temperature in a range of approximately 66 Celsius degrees to approximately 80 Celsius degrees and for a period of time of approximately 10 hours to approximately 18 hours to form a sweetener solution containing a predetermined amount of alpha-glycosyl stevioside, with a conversion rate from the stevioside to the alpha-glycosyl stevioside in a range between approximately 82% to approximately 86%.

The enzymes utilized for the above process are chosen from a group consisting of glucosyltransferase and cyclodextrin glucanotransferase. A predetermined amount of either of these two enzymes must be used in accordance with the above descriptions.

It is worth mentioning that the resulting natural sweetener has a sweet taste very close to traditional sugar, extremely soluble in water, and easy to use. Users may mix the natural sweetener with a wide range of other food products in order to impart those food products with a natural taste of sweetness.

The detailed effect of the natural sweetener can be described as follows: for 5% sucrose solution, conventional sweeteners are sweet, Bitter, no unpleasant after-taste, relatively insoluble under ambient temperature, inconvenience to use. The natural sweeteners of the present invention has improved sweetness, pleasant, taste similar to sucrose, no unpleasant after-taste, and is easy to dissolve under ambient temperature, and convenient to use. For 10% sucrose solution, conventional natural sweeteners are sweet, and have higher level of bitterness, and are relatively insoluble under ambient temperature. The present invention has improved sweetness, pleasant, taste similar to sucrose, no unpleasant after-taste, easy to dissolve under ambient temperature, convenient to use. For 15% sucrose solution, conventional sweeteners are sweet, irritative, and have a very high level of bitterness, and inconvenient to use, whereas the present invention has high quality of sweetness, pleasant, taste similar to sucrose, no unpleasant after-taste, and is easy to dissolve under ambient temperature, and convenient to use.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A natural sweetener composition, comprising:
a predetermined amount of stevioside;
a predetermined amount of dextrin having an equivalent predetermined value of dextrose; and
a predetermined amount of enzyme,
wherein said stevioside, said dextrin and said enzyme are chemically mixed together under a predetermined range of temperature for a period of time to form a sweetener solution containing a predetermined amount of alpha-glycosyl stevioside, with a conversion rate from said stevioside to said alpha-glycosyl stevioside in a predetermined range.

2. The natural sweetener composition, as recited in claim 1, wherein said stevioside has a percentage by weight of 10 to 18, wherein said dextrin has a percentage by weight of 10 to 19, wherein said dextrin has said dextrose equivalent value in a range of approximately 4 to 30, wherein said enzyme has a percentage by weight of approximately 0.06 to 0.25.

3. The natural sweetener composition, as recited in claim 2, wherein said stevioside, said dextrin and said enzyme are chemically mixed together under a temperature in a range of approximately 40 Celsius degrees to 80 Celsius degrees and for a period of time of approximately 3 hours to 30 hours to form said sweetener solution containing a predetermined amount of alpha-glycosyl stevioside, with a conversion rate from said stevioside to said alpha-glycosyl stevioside in a range between approximately 60% to 86%.

4. The natural sweetener, as recited in claim 1, wherein said stevioside has a percentage by weight of approximately 13 to 16, wherein said dextrin has a percentage by weight of 13 to 15, wherein said dextrin has a dextrose equivalent value in a range of approximately 4 to 20, wherein said enzyme has a percentage by weight of approximately 0.09 to 0.22.

5. The natural sweetener, as recited in claim 4, wherein said stevioside, said dextrin and said enzyme are chemically mixed together under a temperature in a range of approximately 55 Celsius degrees to 80 Celsius degrees and for a period of time of approximately 9 hours to 18 hours to form said sweetener solution containing a predetermined amount of alpha-glycosyl stevioside, with a conversion rate from said stevioside to said alpha-glycosyl stevioside in a range between approximately 70% to 86%.

6. The natural sweetener, as recited in claim 1, wherein said stevioside has a percentage by weight of approximately 13 to 16, wherein said dextrin has a percentage by weight of 13 to 15, wherein said dextrin has a dextrose equivalent value in a range of approximately 4 to 20, wherein said enzyme has a percentage by weight of approximately 0.09 to 0.22.

7. The natural sweetener, as recited in claim 6, wherein said stevioside, said dextrin and said enzyme are chemically mixed together under a temperature in a range of approximately 66 Celsius degrees to 80 Celsius degrees and for a period of time of approximately 10 hours to 18 hours to form said sweetener solution containing a predetermined amount of alpha-glycosyl stevioside, with a conversion rate from said stevioside to said alpha-glycosyl stevioside in a range between approximately 82% to 86%.

8. The natural sweetener, as recited in claim 3, wherein said enzymes is selected from the group consisting of glucosyltransferase and cyclodextrin glucanotransferase.

9. The natural sweetener, as recited in claim 5, wherein said enzymes is selected from the group consisting of glucosyltransferase and cyclodextrin glucanotransferase.

10. The natural sweetener, as recited in claim 7, wherein said enzymes is selected from the group consisting of glucosyltransferase and cyclodextrin glucanotransferase.

11. A method of manufacturing a natural sweetener, comprising the steps of:
(a) providing a predetermined amount of stevioside;
(b) providing a predetermined amount of dextrin having an equivalent predetermined value of dextrose;
(c) providing a predetermined amount of enzyme; and
(d) mixing said stevioside, said dextrin, and said enzymes under a predetermined range of temperature for a period of time to form a sweetener solution containing a predetermined amount of alpha-glycosyl stevioside, with a conversion rate from said stevioside to said alpha-glycosyl stevioside in a predetermined range.

12. The method as recited in claim 11 wherein, through the steps (a) to (c), said stevioside has a percentage by weight of 10 to 18, wherein said dextrin has a percentage by weight of 10 to 19, wherein said dextrin has said dextrose equivalent value in a range of approximately 4 to 30, wherein said enzyme has a percentage by weight of approximately 0.06 to 0.25.

13. The method as recited in claim 12 wherein, in the step (d), said stevioside, said dextrin and said enzyme are chemically mixed together under a temperature in a range of approximately 40 Celsius degrees to 80 Celsius degrees and for a period of time of approximately 3 hours to 30 hours to form said sweetener solution containing a predetermined amount of alpha-glycosyl stevioside, with a conversion rate from said stevioside to said alpha-glycosyl stevioside in a range between approximately 60% to 86%.

14. The method as recited in claim 11 wherein, through the steps (a) to (c), said stevioside has a percentage by weight of approximately 13 to 16, wherein said dextrin has a percentage by weight of 13 to 15, wherein said dextrin has a dextrose equivalent value in a range of approximately 4 to 20, wherein said enzyme has a percentage by weight of approximately 0.09 to 0.22.

15. The method as recited in claim 14 wherein, in the step (d), said stevioside, said dextrin and said enzyme are chemically mixed together under a temperature in a range of approximately 55 Celsius degrees to 80 Celsius degrees and for a period of time of approximately 9 hours to 18 hours to form said sweetener solution containing a predetermined amount of alpha-glycosyl stevioside, with a conversion rate from said stevioside to said alpha-glycosyl stevioside in a range between approximately 70% to 86%.

16. The method as recited in claim 11 wherein, through the steps (a) to (c), said stevioside has a percentage by weight of approximately 13 to 16, wherein said dextrin has a percentage by weight of 13 to 15, wherein said dextrin has a dextrose equivalent value in a range of approximately 4 to 20, wherein said enzyme has a percentage by weight of approximately 0.09 to 0.22.

17. The method as recited in claim 16 wherein, in the step (d), said stevioside, said dextrin and said enzyme are chemically mixed together under a temperature in a range of approximately 66 Celsius degrees to 80 Celsius degrees and for a period of time of approximately 10 hours to 18 hours to form said sweetener solution containing a predetermined amount of alpha-glycosyl stevioside, with a conversion rate from said stevioside to said alpha-glycosyl stevioside in a range between approximately 82% to 86%.

18. The method, as recited in claim 13, wherein said enzymes is selected from the consisting of glucosyltransferase and cyclodextrin glucanotransferase.

19. The method, as recited in claim 15, wherein said enzymes is selected from the group consisting of glucosyltransferase and cyclodextrin glucanotransferase.

20. The method, as recited in claim 17, wherein said enzymes is selected from the group consisting of glucosyltransferase and cyclodextrin glucanotransferase.
